(19) United States
(12) Patent Application Publication
(10) Pub. No.: US 2003/0029987 A1
(43) Pub. Date: Feb. 13, 2003

(54) Bell mouth and method for manufacturing box to be buried under ground

(75) Inventors: Yasuhiro Kikumori, Osaka (JP); Yoshiyuki Koizumi, Osaka (JP)

Correspondence Address: McGinn & Gibb, PLLC, Suite 200, 8321 Old Courthouse Road, Vienna, VA, 22182-3817, US

(73) Assignee: Totaku Industries, Inc., Osaka (JP)

(21) Appl. No.: 10/198,096

(22) Filed: Jul. 19, 2002

(30) Foreign Application Priority Data
Jul. 25, 2001 (JP) P. 2001-224731

(51) Int. Cl. B28B 7/24

(52) U.S. Cl. 249/207; 249/120

(57) ABSTRACT

The bell mouth has a first member composed of a cylindrical-shaped body with a trumpet-shaped opening at its one end and including a projection-shaped spiral portion formed on the outer peripheral surface thereof, a second member composed of a cylindrical-shaped body including a projection-shaped annular portion formed on the outer peripheral surface thereof, and a third member composed of a cylindrical-shaped body including a groove-shaped spiral portion formed on the inner peripheral surface at one axial end side thereof and a projection-shaped annular portion formed on the inner peripheral surface at the other axial end side thereof. The spiral portions of the first member and the third member are spirally fitted with each other, and the annular portions of the third member are fitted with each other. Accordingly, it is possible to move the first and third members telescopically with respect to each other through their mutual spiral fit.

### BACKGROUND OF THE INVENTION

The present invention relates to a bell mouth. When a pipe line to protect a cable mainly such as an electric cable, a telephone cable and an optical cable is buried and formed under the ground, the bell mouth is mounted to the side wall of a box to be buried under the ground such as a hand hole or a manhole to be installed as a relay base for the cable and is used to connect together pipe bodies for forming the pipe line (the box to be buried under the ground is hereinafter referred to as a hand hole for convenience of explanation). The present invention also relates to a method for manufacturing a hand hole with such bell mouths buried into the peripheral wall of the hand hole.

As a typical method for installing a hand hole as a cable relay base, there is known a method which digs a hole in the ground for installation of the hand hole by a desired depth and places concrete into the dug hole to thereby form the peripheral wall body of the hand hole on the installation spot. There is also known another typical method which previously forms a box having a predetermined shape in a factory and carries the box to the installation spot and buries it under the ground.

In the case of a hand hole previously formed in a factory, generally, when the hand hole is formed, a bored hole for mounting a bell mouth for connecting the cable line or an easy-to-destruct thin wall portion is formed in the side wall of the hand hole. And, in the installation site, using the bored holes or using the holes have been formed by destructing the thin-wall portions, a required number of bell mouths are in part projected outwardly of the peripheral wall of the hand hole and are fixed by mortaring. And, also in the case of the former method in which the hand hole peripheral body is formed in the installation site, the bell mouths are buried into and fixed to the peripheral wall of the hand hole in such a manner that they are in part projected outwardly of the peripheral wall of the hand hole.

The reason why the bell mouths are formed so as to project in part outwardly of the hand hole peripheral wall is to be able to connect the ends of pipes for forming the pipe line to the outwardly projecting portions of the bell mouths directly, or by inserting the former into the bell-mouth outwardly projecting portions through joints or by fitting the former with the outer surfaces of the bell-mouth outwardly projecting portions.

However, in both of the above-mentioned conventional methods, it takes time and labor to obtain a hand hole with bell mouths in the hand hole installation site. In fact, there are few cases in which only one bell mouth is mounted on a hand hole and, in many cases, a relatively large number of bell mouths must be mounted collectively; for example, three bell mouths must be disposed horizontally so as to adjoin one another in the vertical two or three stages, that is, a total of 6 or 9 bell mouths must be used. In these cases, it takes much time and labor to install the hand hole.

Also, not only in the operation for installing a hand hole in the installation site but also in the operation for mounting a bell mouth onto a previously formed hand hole, even in case where the bell mouth mounting operation is completed, the bell mouth cannot be connected to the pipe line immediately before a hardener such as cement or mortar hardens.

### SUMMARY OF THE INVENTION

The present invention aims at eliminating the drawbacks found in the above-mentioned conventional hand hole forming means. Accordingly, it is an object of the invention to provide a hand hole manufacturing method which employs the latter method of the above-mentioned conventional methods for previously forming a hand hole in other places than a hand hole installation site, eliminates an operation for mounting the bell mouth in the hand hole installation site, and buries a required number of bell mouths into the peripheral wall of a hand hole at the same time when the hand hole is formed in a factory, thereby being able to manufacture efficiently and quickly a hand hole hard to break in transit. And, it is another object of the invention to provide a bell mouth suitable for the present hand hole manufacturing method.

In attaining the above objects, according to a first aspect of the invention, there is provided a bell mouth having a first structure which will be described using reference characters so shown in the drawings as to correspond to the embodiment of a bell mouth according to the invention. That is, the present bell mouth comprises: a bell mouth comprising:

a first member 1 having

a cylindrical-shaped body 10 including a trumpet-shaped opening 13 so formed on an one axial end side thereof as to extend outwardly in a radial direction thereof, and a projection-shaped or groove-shaped spiral portion 12 formed on the outer peripheral surface 11 thereof;

a second member 2 having

a cylindrical-shaped body 20 including a projection-shaped or groove-shaped annular portion 22 formed on the outer peripheral surface 21 thereof; and,

a third member 3 having

a cylindrical-shaped body 30 including a groove-shaped or projection-shaped spiral portion 32 formed on an inner peripheral surface 31a at an one axial side thereof, and a groove-shaped or projection-shaped annular portion 33 formed on an inner peripheral surface 31b at the other axial side thereof,

wherein the spiral portion 12 of the first member 1 and the spiral portion 32 of the third member 3 are spirally fitted with each other, to thereby move the first and third members 1 and 3 telescopically with respect to each other through their mutual spiral fit, and

the annular portion 22 of the second member 2 and the annular portion 33 of the third member 3 are fitted with each other, to thereby form an integrally cylindrical shape.

And, according to a second aspect of the invention, there is provided a bell mouth having a second structure. That is, the bell mouth comprises:

a first member 1 having

a cylindrical-shaped body 10 including a trumpet-shaped opening 13 so formed on an one axial end side thereof as to extend outwardly in a radial direction thereof, and a projection-shaped or groove-shaped annular portion 14 formed on the outer peripheral surface 11 thereof;

a second member 2 having

a cylindrical-shaped body 20 including a projecting-strip shaped or groove-shaped spiral portion 24 formed on the outer peripheral surface 21 thereof; and,

a third member 3 having

a cylindrical-shaped body 30 including a groove-shaped or projection-shaped annular portion 34 formed on an inner peripheral surface 31a at an one axial side thereof, and a groove-shaped or projection-shaped spiral portion 35 formed on the other inner peripheral surface 31b thereof,

wherein the annular portion 14 of the first member 1 and the annular portion 34 of the third member 3 are fitted with each other, to thereby form an integrally cylindrical shape, and

the spiral portion 24 of the second member 2 and the spiral portion 35 of the third member 3 are spirally fitted with each other, to thereby move the second and third members 1 and 3 telescopically with respect to each other through their mutual spiral fit.

Also, according to a third aspect of the invention, there is provided a bell mouth having a third structure. That is, according to the third structure, in the first and second structure, each of the first member 1, second member 2 and third member 3 is a single molding formed of synthetic resin material.

Further, according to a fourth aspect of the invention, there is provided a bell mouth having a fourth structure. That is, according to the fourth structure, a bell mouth comprises:

a first member 4 formed of soft synthetic resin and having

a cylindrical-shaped body 40 including a trumpet-shaped opening 13 so formed on an one axial end side thereof as to extend outwardly in a radial direction thereof, one or more projection-shaped or groove-shaped annular portion 42 formed in the inner peripheral surface 41 thereof on the other axial end side thereof, and a bellows-shaped wall body 44 formed in an axial middle portion of the first member; and,

a second member 5 having

a cylindrical-shaped body 50 including one or more projection-shaped or groove-shaped annular portion 52 formed on the outer peripheral surface 51 thereof,

wherein the annular portion 42 of the first member 4 and the annular portion 52 of the second member 5 are fitted with each other, to thereby form an integrally cylindrical shape, and

the bellows-shaped wall body 44 of the first member 4 can be expanded or compressed through a deformation of the bellows-shaped wall body 44 in the axial direction of the first member.

And, according to a fifth aspect of the invention, there is provided a bell mouth having a fifth structure. That is, according to the fifth structure, in the fourth structure, at least one of the first member 4 and the second member 5 includes a plurality of the annular portions 42 or 52 so that an entire axial length of the bell mouth can be changed by selecting the number of the annular portion 42 of the first member 4 to be fitted with the annular portion 52 of the second member 5.

Also, according to a sixth aspect of the invention, there is provided a bell mouth having a sixth structure. That is, according to the sixth structure,

a first member 4 formed of soft synthetic resin and having

a cylindrical-shaped body 40 including a trumpet-shaped opening 13 so formed on an one axial end side thereof as to extend outwardly in a radial direction thereof, a projection-shaped or groove-shaped spiral portion 45 formed in the inner peripheral surface 41 thereof on the other axial end side thereof, and a bellows-shaped wall body 44 formed in an axial middle portion of the first member; and,

a second member 5 having

a cylindrical-shaped body 50 including a projection-shaped or groove-shaped spiral portion 55 formed on the outer peripheral surface 51 thereof,

wherein the spiral portion 44 of the first member 4 and the spiral portion 55 of the second member 5 are spirally fitted with each other, to thereby move the first and second members 1 and 3 telescopically with respect to each other through their mutual spiral fit, and

the bellows-shaped wall body 44 of the first member 4 can be expanded or compressed through a deformation of the bellows-shaped wall body 44 in the axial direction of the first member.

Now, according to a seventh aspect of the invention, there is provided a method for manufacturing a box to be buried under the ground. That is, the present box manufacturing method comprises the steps of:

disposing an inner molding 7 in the interior of an outer frame 6 while keeping a predetermined space therebetween to be a peripheral wall A of the box;

disposing a given number of bell mouths each including a trumpet-shaped opening 13 formed on an one axial end thereof and being adjustable in the axial-direction length thereof, within the predetermined space a in such a manner that the bell mouths B lie horizontally with the trumpetshaped openings 13 facing the side of the inner mold 7;

fixing the bell mouths B between the inner mold 7 and the outer frame 6;

placing a solidifyable material into the predetermined space;

solidifying the solidifyable material; and

removing the inner mold 7 and the outer frame 6 after solidification of the solidifyable material, thereby manufacturing the box with the given number of bell mouths B buried into the peripheral wall A of the box.

And, according to an eighth aspect of the invention, in the box manufacturing method as set forth in the seventh aspect, wherein the inner mold 7 is made of ferromagnetic metal, and the method further comprising:

fixing the bell mouths B relative to the inner mold 7 by using a magnet member m that is inserted into the respective interior portions of the bell mouths B.

Further, according to an eighth aspect of the invention, in the box manufacturing method as set forth in the seventh aspect, the solidifyable material is concrete mortar.

Now, according to a ninth aspect of the invention, there is provided a method for manufacturing a box to be buried under the ground. That is, the present box manufacturing method comprises the steps of:

disposing an inner molding 7 in the interior of an outer frame 6 while keeping a predetermined spaces therebetween to be a peripheral wall A of the box;

disposing a given number of bell mouths according to one of the first to sixth aspects of the present invention, within the predetermined space A in such a manner that the bell mouths B lie horizontally with the trumpet-shaped openings 13 facing the side of the inner mold 7;

fixing the bell mouths B between the inner mold 7 and the outer frame 6;

placing a solidifyable material into the predetermined space A;

solidifying the solidifyable material; and

removing the inner mold 7 and the outer frame 6 after solidification of the solidifyable material, thereby manufacturing the box with the given number of bell mouths B buried into the peripheral wall A of the box.

In the above-mentioned method, it is preferable that the solidifyable material is concrete mortar.

### BRIEF DESCRIPTION OF THE DRAWINGS

FIG. 1 is a transverse sectional front section view of an upper half section of a bell mouth according to a first embodiment of the invention;

FIG. 2 is a transverse sectional front section view of the upper half section of the bell mouth according to the first embodiment, showing a state of the bell mouth in which it is extended;

FIG. 3 is a transverse sectional front section view of an upper half section of a bell mouth according to a second embodiment of the invention;

FIG. 4 is a transverse sectional front section view of the upper half section of the bell mouth according to the second embodiment, showing a state of the bell mouth in which it is extended;

FIG. 5 is a transverse sectional front section view of an upper half section of a bell mouth according to a third embodiment of the invention;

FIG. 6 is a transverse sectional front section view of the upper half section of the bell mouth according to the second embodiment, showing a state of the bell mouth in which it is compressed;

FIG. 7 is a transverse sectional front section view of an upper half section of a bell mouth according to a fourth embodiment of the invention;

FIG. 8 is a transverse sectional front section view of an upper half section of a bell mouth according to a fifth embodiment of the invention;

FIG. 9 is a longitudinal section view of the main portions of a hand hole, explaining a manufacturing method for manufacturing the hand hole;

FIG. 10 is an enlarged view of the main portions of the right half section of FIG. 9;

FIG. 11 is a longitudinal section view of the main portions of a hand hole manufactured according to the above manufacturing method; and,

FIG. 12 is an enlarged view of the portions of a hand hole corresponding to FIG. 10, explaining another manufacturing method.

### DETAILED DESCRIPTION OF THE PREFERRED EMBODIMENTS

In enforcing the bell mouths respectively having the above-mentioned first to sixth structures according to the invention, preferably, in the mutually opposed clearances of the respective members, there may be disposed, for example, O-rings, or O-shaped annular seal members, or packing members.

Also, in manufacturing the hand holes respectively having the seventh and eighth structures according the present invention, in case where closed caps such as shallow-plate-shaped dustproof caps c are mounted on the outer openings of the respective bell mouths B, - - - , there can be obtained a hand hole with the openings on the outer peripheral surface thereof closed; that is, after the hand hole is manufactured, there can be omitted time and labor to mount dustproof caps on the openings of the respective mouths B, - - - to thereby close the openings. This is advantageous in that, when connecting a pipe line in the hand hole installation site, the pipe line can be connected by removing only the dustproof caps of the bell mouths used to connect the pipe line and, as the bell mouths unused or the remaining bell mouths are left as they are, the outside of the hand hole can be covered with earth.

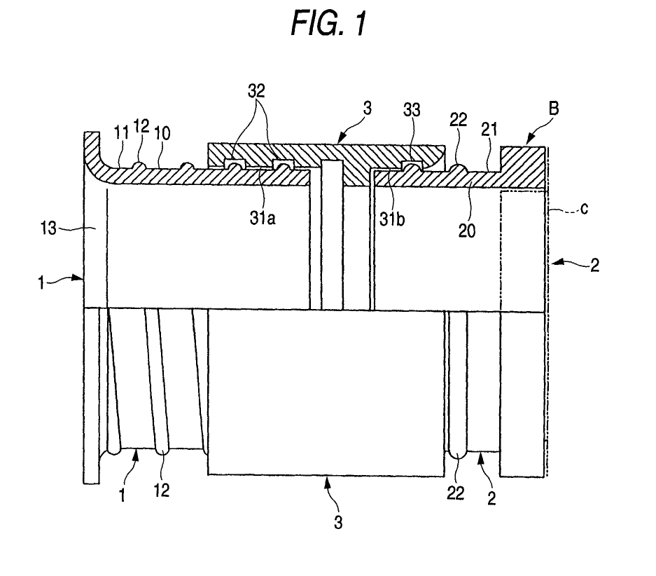

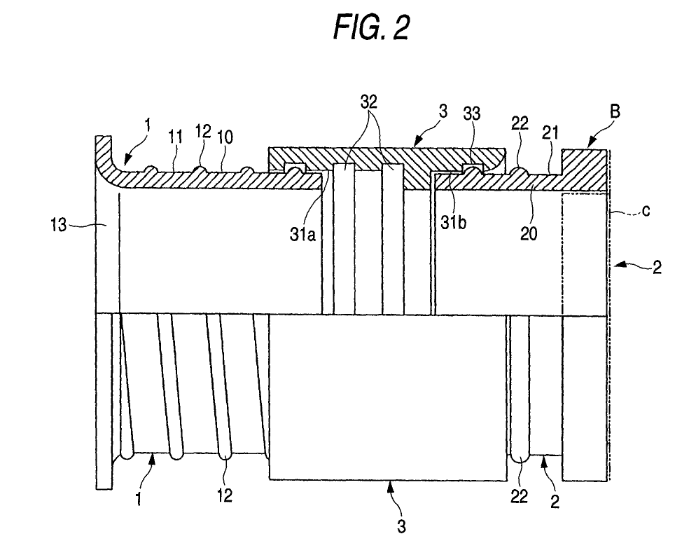

Now, description will be given below of the preferred embodiments of a bell mouth according to the invention with reference to the accompanying drawings. In the drawings, FIG. 1 is a transverse sectional front view of an upper half section of a bell mouth according to a first embodiment of the invention, and FIG. 2 is a transverse sectional front view of an upper half section of the bell mouth shown in FIG. 1, showing a state in which the whole length of the bell mouth is extended.

The bell mouth B according to the first embodiment is composed of the following three members, that is, a first member 1, a second member 2 and a third member 3; and, the three members are connected together in the axial direction of the bell mouth B and are thereby formed in an integrally cylindrical shape as a whole. The first member 1 is composed of a resin-made cylindrical-shaped body 10 which, one opening thereof, that is, in FIGS. 1 and 2, a left opening 13 is formed so as to spread out in a trumpet shape; and, the cylindrical-shaped body 10 includes an outer peripheral surface 11 and a spiral portion 12 which is provided on and projected from the outer peripheral surface 11 in a projecting strip shape and also which is formed integrally with the outer peripheral surface 11. The second member 2 is composed of a resin-made cylindrical-shaped body 20; and, the cylindrical body 20 includes an outer peripheral surface 21 and a annular portion 22 which is provided on and projected from the outer peripheral surface 21 in a projecting strip shape and also which is formed integrally with the outer peripheral surface 22. The third member 3 is also composed of a resin-made cylindrical-shaped body 30. In one of the inner peripheral surfaces of the cylindrical-shaped body 30, that is, in the inner peripheral surface 31a which is situated in the left half section of the cylindrical-shaped body 20 in FIGS. 1 and 2, there is formed a spiral portion 32 which is recessed in a groove-strip shape; and, in the other inner peripheral surface 31b, there is formed a annular portion 33 recessed in a grooved-strip shape.

Specifically, to form these three members 1, 2 and 3 into an integrally cylindrical shape, the first member 1 may be rotated and inserted into the third member 3 such that the spiral portion 12 of the first member 1 is spirally fitted with the spiral portion 32 of the third member 3 to thereby connect together the first and third members 1 and 3; and, on the other hand, the annular portion 22 of the second member 2 may be fitted with the annular portion 33 of the third member 3 in such a manner that they are hard to slip off from each other. And, according to the present bell mouth B, in case where the first member 1 is rotated in any direction with respect to the third member 3, the length of the bell mouth B in the axial direction thereof can be adjusted, that is, can be extended and compressed due to the spiral fit between the spiral portion 32 and spiral portion 12.

Now, FIG. 2 shows a state of the bell mouth B shown in FIG. 1 in which, as described above, by rotating the first member 1 counterclockwise with respect to the third member 3, the range of the spiral fit between the spiral portion 32 and spiral portion 12 is made smaller by 1 pitch and the axial-direction length of the bell mouth B is extended by 1 pitch width. The remaining portions of FIG. 2 are similar to those of FIG. 1.

By the way, in FIGS. 1 and 2, a virtual line designated by reference character c shows a shallow-plate-shaped dustproof cap which is formed by blow molding synthetic resin sheet mother material; and, more specifically, the virtual line c shows a state of the dustproof cap in which the dustproof cap is mounted into the outer opening of the second member 2 of the bell mouth B as an opening closing cap (a cap for closing the outer opening of the second member 2). As the dustproof cap, there can be used other caps such as a rubber-made cap and a resin injection-molded cap.

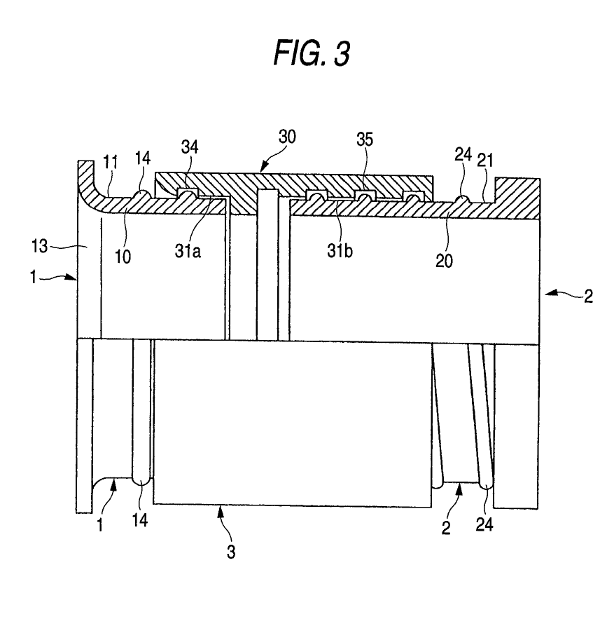

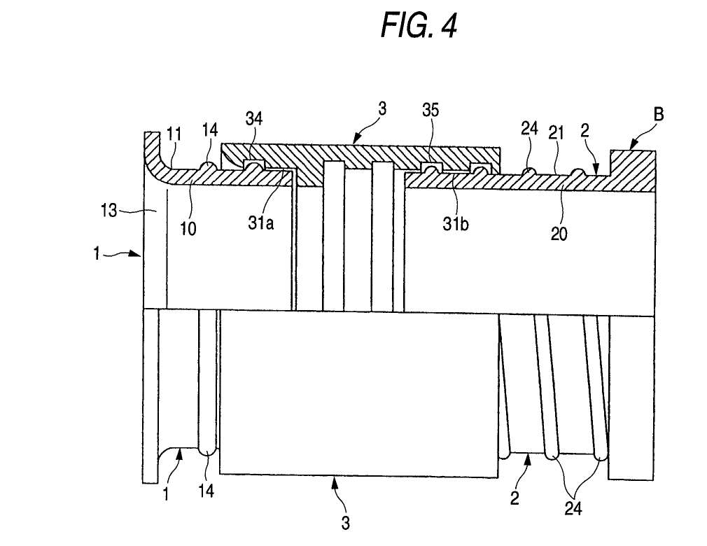

Now, FIGS. 3 and 4, similarly to FIGS. 1 and 2, are transverse sectional front views of an upper half section of a bell mouth. Specifically, FIGS. 3 and 4 respectively show a bell mouth B according to a second embodiment of the invention having a modified version of the structure of the bell mouth B according to the previously described first embodiment of the invention. In the bell mouth according to the second embodiment, a first member 1 includes a projection-shaped annular portion 14 provided on the outer peripheral surface 11 of a cylindrical-shaped body 10 having a trumpet-shaped opening 13 in one end thereof. A second member 2 includes a projected-shaped spiral portion 24 provided on the outer peripheral surface 21 of a cylindrical-shaped body 20. A third member 3 includes a groove-shaped annular portion 34 provided in one inner peripheral surface 31a of a cylindrical-shaped body 30 and a groove-shaped annular portion 35 provided on the other inner peripheral surface 31b of the cylindrical-shaped body 30. The annular portion 14 of the first member 1 is fitted with the annular portion 34 of the third member 3, and the spiral portion 24 of the second member 2 is spirally fitted with the spiral portion 35 of the third member 3, thereby forming an integrally cylindrical shape. And, by operating or rotating the second member 2 with respect to the third member 3, the length of the whole bell mouth B can be adjusted, that is, can be extended and reduced. Here, FIG. 4 shows a state of the bell mouth B in which the length of the bell mouth B shown in FIG. 3 is extended through the above rotational operation by an amount corresponding to 1 pitch width of the spiral portion 24 of the second member 2. Also, as a modification of the first and second embodiments, of course, the fit portions of the first and third members and the fit portions of the second and third members may also be attained by spiral fit.

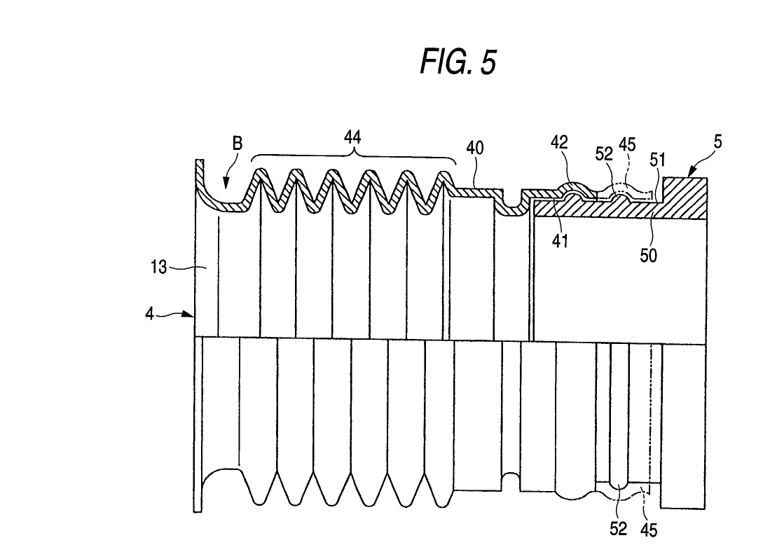

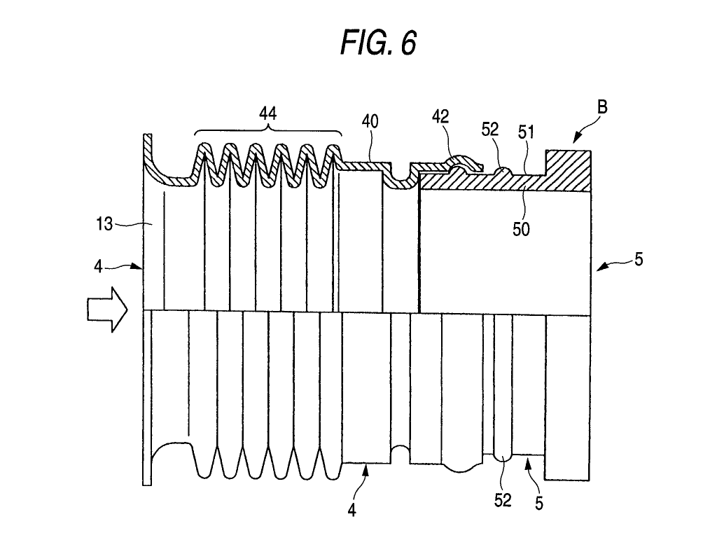

Now, FIGS. 5 and 6 show a bell mouth B which is different in structure from the bell mouth B shown in the first embodiment. This structure will be described below as a third embodiment according to the invention. The bell mouth B according to the third embodiment is composed of two members, that is, a first member 4 and a second member 5. The first member 4 is a molding which is made of soft synthetic resin mother material. And, the first member 4 includes a groove-shaped annular portion 42 provided on the inner peripheral surface 41 of the other-end side portion of a cylindrical-shaped body 40 having a trumpet-shaped opening 13 in one end thereof; and, a wall body 44, which is disposed in the middle portions of the two portions 13 and 41 and has a proper length, is formed as a triangularly undulated annular bellows. The second member 5 is composed of a cylindrical-shaped member 50 and includes a projection-shaped annular portion 52 formed on the outer peripheral surface 51 of the cylindrical-shaped member 50. In the third embodiment, by pressure inserting the second member 5 into the first member 4 in the axial direction thereof, the annular portion 42 of the first member 4 is fitted with the annular portion 52 of the second member 5, thereby connecting together the first and second members 4 and 5 into an integrally cylindrical shape. Thus, the wall body 44 portion of the first member 4, which is formed as the above-mentioned bellows-shaped body, is structured such that, due to the bellows-like shape thereof, in case where an external pressure is applied to the wall body 44 portion in the axial direction thereof, it can be compressed and deformed.

Now, FIG. 6 shows a state of the bell mouth B in which, as shown by an arrow mark in the central portion of the left side in FIG. 6, when pressure is applied to the bell mouth B in the axial direction thereof, the wall body 44 portion formed in a bellows-like shape is compressed in the axial direction over the state thereof shown in FIG. 5 (no-load state) due to deformation of the bellows-like portion thereof and thus the whole length of the bell mouth B is reduced accordingly.

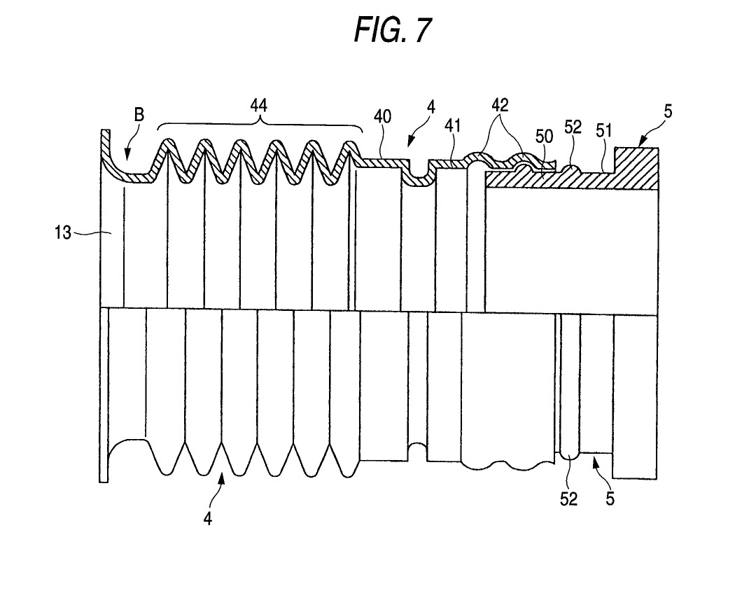

Now, FIG. 7 shows a fourth embodiment of the invention which is a modification of the structure according to the third embodiment shown in FIG. 5. In the fourth embodiment, as shown by a virtual line 45 in the opening portion formed on the right side in FIG. 5, the annular portion 42 formed in the first member 4 is composed of a plurality of annular bodies, the annular portion 52 of the second member 5 is also composed of a plurality of annular bodies, and the annular portion 42 and annular portion 52 can be selectively fitted with each other; and, such selective fit makes it possible to set the whole length of the bell mouth B substantially at a proper length. In FIG. 7, although the annular portion 42 and annular portion 52 are shown by twos each, it goes without saying that they may be composed of three or more as the need arises. Also, in case where the leading end sides of the plurality of annular bodies 42 of the first member 4 except for one of them are cut away, there can be provided the same structure as shown in the previously described embodiment shown in FIG. 5.

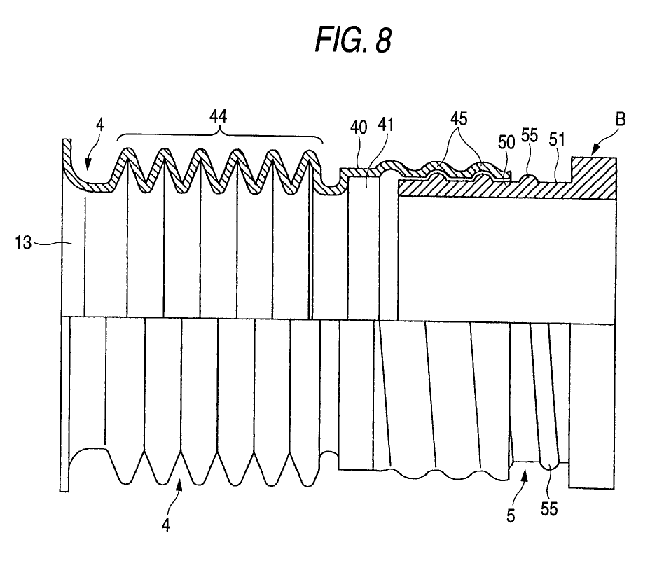

Now, FIG. 8 shows a fifth embodiment of the invention which is a further modification of the structure according to the third embodiment shown in FIG. 5. The fifth embodiment is different from the third embodiment in that a groove-strip body (or a projecting-strip body) formed in the inner peripheral surface 41 of the other end side of the first member 4 is composed of a spiral portion 45 and, in correspondence to this, a projecting-strip body (or groove-strip body) formed in the outer peripheral surface 51 of the second member 5 is composed of a spiral portion 55. In the bell mouth B according to the present embodiment, the whole length of the bell mouth B can be adjusted due to the following two operations: that is, the adjustment of the length through spiral fit between the spiral portion 54 and spiral portion 55, and the compressive deformation of the bellows-shaped wall body 44 portion of the first member 4 in the axial direction thereof. By the way, in the embodiments respectively shown in FIGS. 5 to 8, the state of fit between the first and second members 4 and 5 may also be reversed, that is, the two members 4 and 5 may be fitted with each other in such a manner that the first member 4 is inserted into the second member 5.

In the bell mouths B according to the above-mentioned embodiments of the invention, in enforcing them, between the mutually opposed clearances of the respective members, there can be interposed an O ring, or an O-annular seal, or a packing member. Such interposition is preferred in that, in use, concrete can be prevented from intruding into the bell mouth B. Also, the first members of the bell mouths B may also be formed of flexible material, and the trumpet-shaped opening 13 may also be formed such that it becomes thinner as it goes toward the leading end thereof and thus it can be flexed according to pressure applied thereto.

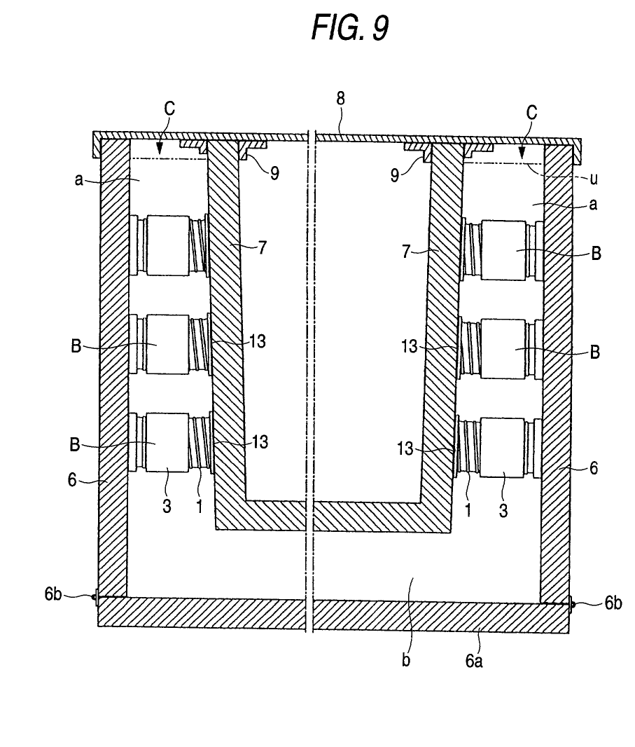

Next, description will be given below of a method for manufacturing a hand hole H serving as a box to be buried under the ground using the above-described bell mouth the length of which can be changed and adjusted. Here, FIGS. 9 to 11 are respectively explanatory views of the hand hole H manufacturing method. In FIGS. 9 to 11, as a bell mouth B to be used in the present hand hole H manufacturing method, for convenience of explanation, there is shown the bell mouth B which has been described in connection with the first embodiment. However, the present hand hole H manufacturing method is not limited to the bell mouth B according to the first embodiment but it is also able to use other bell mouths B different in structure, provided that they can be changed and adjusted in length.

Firstly, as can be seen in FIG. 9, on the four peripheries of a bottom plate 6a, there is erected an outer frame 6. In FIG. 9, the outer frame 6 is shown as a plate body which is luffably connected to the bottom plate 6a by hinges 6b, - - - . On the other hand, in the interior of the outer frame 6, there is disposed a bottomed inner mold 7 with given spaces a and b with respect to the whole surface of the outer frame 6 and the upper surface of the bottom plate 6a. Here, the inner mold 7 is formed such that it is smaller than the outer frame 6 in the whole size by an amount corresponding to the thickness of the peripheral wall of the finished hand hole H. The given spaces a and b, of course, are spaces which respectively have widths corresponding to the thickness of the peripheral wall A and the thickness of the bottom wall f of the finished hand hole H.

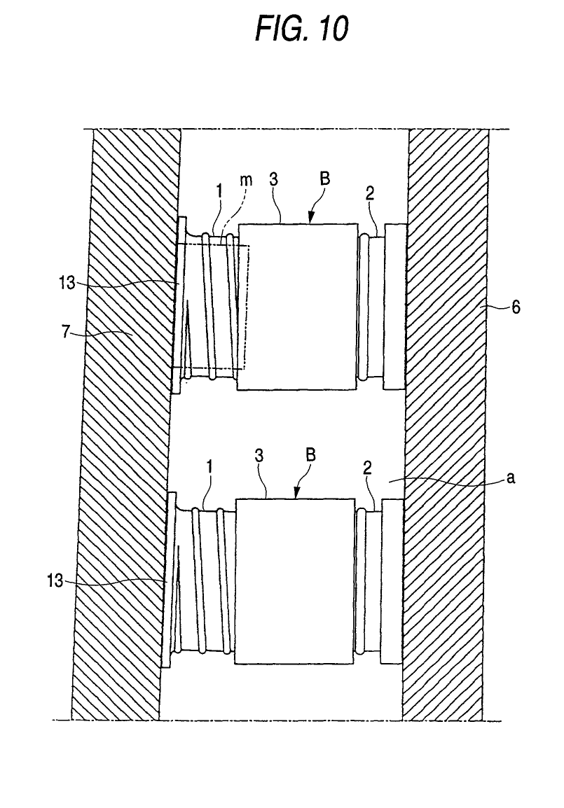

Thus, a required number of bell mouths B, - - - , each of which includes a trumpet-shaped opening 13 formed in one end portion thereof and can be adjusted in the axial-direction length thereof, are disposed, (of four spaces a respectively existing in the four peripheries of the bottom plate 6a), in spaces existing in directions necessary for formation of the pipe line, in FIG. 9, in the two mutually opposed right and left spaces a and a in such a manner that, as shown enlargedly in FIG. 10, the bell mouths B lie horizontally with their respective trumpet-shaped openings 13 contacted with the inner mold 7; and, at the same time, while the first members 1 of the respective bell mouths B are rotated with respect to their associated third members 3 counterclockwise to thereby extend the lengths of the respective bell mouths B to the required lengths, the bell mouths B are fixed sequentially between the inner mold 7 and outer frame 6. As shown in FIGS. 9 and 10, the inner mold 7 is formed such that its outer peripheral surface has a removing incline necessary for an operation to remove the inner mold 7 from the hand hole H after the concrete is cured. Therefore, the bell mouths B arranged in the upper stages are different in length from the bell mouths B arranged in the lower stages; and thus, the bell mouths B must be adjusted to the lengths that are suitable for their respective installation portions, before they are mounted.

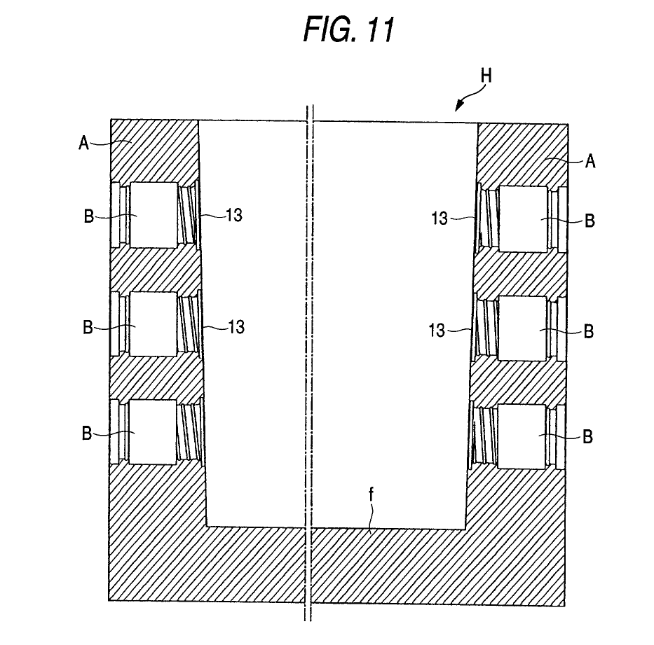

After then, concrete and mortar are placed into the spaces a and b to a designed load line u, the whole frame is vibrated to thereby discharge and remove the air mixed in the placed concrete upwardly of the frame, the concrete and mortar are cured for a given period of time and are thus solidified and, after then, the inner mold 7 and outer frame 6 are removed from the frame, thereby manufacturing a hand hole H in which, as shown in FIG. 11, the required number of bell mouths B, - - - are buried in the peripheral walls A thereof. In FIG. 9, reference character 8 shown in the top portion thereof designates a hanging support frame for the inner mold 7 to which the inner mold 7 is fixed by inner mold fixing frames 9; and, the hanging support frame 8 is used not only to maintain the spaces a at given clearances but also to prevent the outer frame 6 from moving or opening outwardly.

Here, FIG. 10 shows an enlarged view of a hand hole, showing a state thereof in which the bell mouths B are mounted into the space a between the outer frame 6 and inner mold 7 according to the present manufacturing method. Thus, in case where the inner mold 7 is made of a ferromagnetic metal member such as an iron plate or an iron casting, or in case where the inner mold 7 is composed of a wooden plate and an iron plate pasted on the surface of the wooden plate, as shown by a virtual line in FIG. 10, a magnet m may be fitted into the interior of the opening of the bell mouth B and thus the bell mouth B may be fixed to the inner mold 7 due to the attracting force of the magnet m. This method is not limited to the inner mold 7 but it can also be applied to the outer frame 6; that is, this method can be applied to both of the inner mold 7 and outer frame 6.

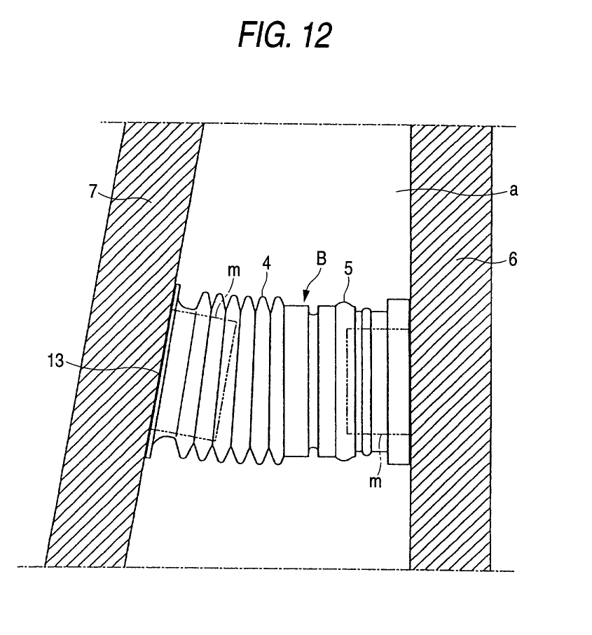

Now, FIG. 12 corresponds to FIG. 10 and is an enlarged view of a method in which a hand hole H is manufactured using the bell mouth B illustrated as the third embodiment in FIGS. 5 and 6. In FIG. 12, the inclination angle of the inner mold 7 is shown exaggeratedly. Even in case where the inclination angle of the inner mold 7 is large in this manner, since the bellows portion not only can be compressed and deformed in the axial direction but also can be curved and deformed, the trumpet-shaped opening 13 can be advantageously arranged closely along the inclination of the inner mold 7. By the way, in FIG. 12, a virtual line shows a case where the magnet m is used with respect to both of the inner mold 7 and outer frame 6.

By the way, although not shown, the number of bell mouths B to be buried and the burying states of the bell mouths B to be buried into the hand hole H are not limited to the illustrated arrangement in which the bell mouths B are arranged in the single vertical line but depend on the number of pipe lines to be installed. For example, for a single wall surface, the bell mouths B may be arranged in three vertical stages and three horizontal rows, a total of 9; or, in two vertical stages and four horizontal rows, a total of 8; that is, the bell mouths B may be buried in a plurality of vertical stages and a plurality of horizontal rows according to cases. However, the manufacturing method of the invention can also apply to the manufacture of a hand hole H into which only one bell mouth is buried.

While description has been given heretofore of the typical embodiments of the invention, the invention is not limited only to the above-mentioned structures and methods of the embodiments but various changes and modifications are also possible, provided that they comprise the above-mentioned composing elements, can attain the above object of the invention, and can provide the following effects.

As can be understood clearly from the foregoing description, the bell mouths, which are buried into the side wall of a box to be buried under the ground such as a hand hole and a manhole, vary greatly in size according to whether they are used in the hand hole or manhole; even in case where the bell mouths are used in the same hand hole or in the same manhole, they are variously different in size; and, the wall thicknesses of the bell mouths vary according to the sizes of the bell mouths. Due to this, in order to make the bell mouths correspond to various kinds of side walls having different wall thicknesses, there are necessary several kinds of bell mouths differing in size. On the other hand, the bell mouth according to the invention is structured such that the length of the bell mouth itself can be changed, that is, extended or reduced to a desired length; and, therefore, the present bell mouth can be used so as to correspond to various kinds of boxes to be buried under the ground differing in the wall thickness. Also, even in case where an inner mold having a removing inclination for removal thereof after curing of the concrete is used, by adjusting, that is, extending or reducing the length of the bell mouth, the present bell mouth can be used as a bell mouth having an optimum length. In other words, according to the invention, outstanding effects can be expected.

Also, according to the first and second aspects of the invention, in the case of a bell mouth composed of three members, that is, the first, second and third members, when it is used for formation of the box to be buried under the ground, in the pressure contact final stage of the bell mouth with respect to the outer frame and inner molding, not only the first and second members are respectively contacted with the inner molding and outer frame but also the third member serving as the middle member is rotated, the first and second members can be extended in the axial direction thereof and can be thereby pressure contacted respectively with the inner molding and outer frame without rotating them. This provides an advantage that the present bell mouth can be positively mounted on and fixed to a previously set portion of the box to be buried under the ground.

Further, according to a method for manufacturing a box to be buried under the ground as set forth in the third aspect of the invention, there is used the above-mentioned bell mouth the length of which can be changed in an extending or reducing manner and the present bell mouth is inserted into the wall of the hand hole. Thanks to this, the mounting portions of the bell mouths and the number of bell mouths to be mounted can be properly matched to the necessary portions and number. This provides an outstanding effect that various kinds of boxes to be buried under the ground differing in the mounting portions of the bell mouths and the number of bell mouths to be mounted can be manufactured easily without changing the outer frame and inner mold.

What is claimed is:

1. A bell mouth comprising:
a first member (1) having
a cylindrical-shaped body (10) including a trumpet-shaped opening (13) so formed on an one axial end side thereof as to extend outwardly in a radial direction thereof, and a projection-shaped or groove-shaped spiral portion (12) formed on the outer peripheral surface (11) thereof;
a second member (2) having
a cylindrical-shaped body (20) including a projection-shaped or groove-shaped annular portion (22) formed on the outer peripheral surface (21) thereof; and,
a third member (3) having
a cylindrical-shaped body (30) including a groove-shaped or projection-shaped spiral portion (32) formed on an inner peripheral surface (31a) at an one axial side thereof, and a groove-shaped or projection-shaped annular portion (33) formed on an inner peripheral surface (31b) at the other axial side thereof,
wherein said spiral portion (12) of said first member (1) and said spiral portion (32) of said third member (3) are spirally fitted with each other, to thereby move said first and third members (1) and (3) telescopically with respect to each other through their mutual spiral fit, and
said annular portion (22) of said second member (2) and said annular portion (33) of said third member (3) are fitted with each other, to thereby form an integrally cylindrical shape.

2. The bell mouth as set forth in claim 1, wherein each of said first member, said second member (2) and said third member (3) is a single molding formed of synthetic resin material.

3. A bell mouth comprising:
a first member (1) having
a cylindrical-shaped body (10) including a trumpet-shaped opening (13) so formed on an one axial end side thereof as to extend outwardly in a radial direction thereof, and a projection-shaped or groove-shaped annular portion (14) formed on the outer peripheral surface (11) thereof;
a second member (2) having
a cylindrical-shaped body (20) including a projecting-strip shaped or groove-shaped spiral portion (24) formed on the outer peripheral surface (21) thereof; and,
a third member (3) having
a cylindrical-shaped body (30) including a groove-shaped or projection-shaped annular portion (34) formed on an inner peripheral surface (31a) at an one axial side thereof, and a groove-shaped or projection-shaped spiral portion (35) formed on the other inner peripheral surface (31b) thereof,
wherein said annular portion (14) of said first member (1) and said annular portion (34) of said third member (3) are fitted with each other, to thereby form an integrally cylindrical shape, and
said spiral portion (24) of said second member (2) and said spiral portion (35) of said third member (3) are spirally fitted with each other, to thereby move said second and third members (1) and (3) telescopically with respect to each other through their mutual spiral fit.

4. The bell mouth as set forth in claim 3, wherein each of said first member, said second member (2) and said third member (3) is a single molding formed of synthetic resin material.

5. A bell mouth, comprising:
a first member (4) formed of soft synthetic resin and having
a cylindrical-shaped body (40) including a trumpet-shaped opening (13) so formed on an one axial end side thereof as to extend outwardly in a radial direction thereof, one or more projection-shaped or groove-shaped annular portion (42) formed in the inner peripheral surface (41) thereof on the other axial end side thereof, and a bellows-shaped wall body (44) formed in an axial middle portion of said first member; and,
a second member (5) having
a cylindrical-shaped body (50) including one or more projection-shaped or groove-shaped annular portion (52) formed on the outer peripheral surface (51) thereof,
wherein said annular portion (42) of said first member (4) and said annular portion (52) of said second member (5) are fitted with each other, to thereby form an integrally cylindrical shape, and
said bellows-shaped wall body (44) of said first member (4) can be expanded or compressed through a deformation of said bellows-shaped wall body (44) in the axial direction of said first member.

6. The bell mouth as set forth in claim 5, wherein at least one of said first member (4) and said second member (5) includes a plurality of said annular portions (42 or 52) in such a manner that an entire axial length of said bell mouth can be changed by selecting the number of said annular portion (42) of said first member (4) to be fitted with said annular portion (52) of said second member (5).

7. A bell mouth, comprising:
a first member (4) formed of soft synthetic resin and having
a cylindrical-shaped body (40) including a trumpet-shaped opening (13) so formed on an one axial end side thereof as to extend outwardly in a radial direction thereof, a projection-shaped or groove-shaped spiral portion (45) formed in the inner peripheral surface (41) thereof on the other axial end side thereof, and a bellows-shaped wall body (44) formed in an axial middle portion of said first member; and,
a second member (5) having
a cylindrical-shaped body (50) including a projection-shaped or groove-shaped spiral portion (55) formed on the outer peripheral surface (51) thereof,
wherein said spiral portion (44) of said first member (4) and said spiral portion (55) of said second member (5) are spirally fitted with each other, to thereby move said first and second members (1) and (3) telescopically with respect to each other through their mutual spiral fit, and
said bellows-shaped wall body (44) of said first member (4) can be expanded or compressed through a deformation of said bellows-shaped wall body (44) in the axial direction of said first member.

8. A method for manufacturing a box to be buried under the ground, comprising:
disposing an inner molding (7) in the interior of an outer frame (6) while keeping a predetermined space (a) therebetween to be a peripheral wall (A) of the box;
disposing a given number of bell mouths each including a trumpet-shaped opening (13) formed on an one axial end thereof and being adjustable in the axial-direction length thereof, within said predetermined space (a) in such a manner that said bell mouths (B) lie horizontally with said trumpet-shaped openings (13) facing the side of said inner mold (7);
fixing said bell mouths (B) between said inner mold (7) and said outer frame (6);
placing a solidifyable material into said predetermined space (a);
solidifying said solidifyable material; and
removing said inner mold (7) and said outer frame (6) after solidification of said solidifyable material, thereby manufacturing said box with said given number of bell mouths (B) buried into the peripheral wall (A) of said box.

9. The method as set forth in claim 8, wherein said solidifyable material is concrete mortar.

10. The method as set forth in claim 8, wherein said inner mold (7) is made of ferromagnetic metal, and said method further comprising:
fixing said bell mouths (B) relative to said inner mold (7) by using a magnet member (m) that is inserted into the respective interior portions of said bell mouths (B).

11. A method for manufacturing a box to be buried under the ground, comprising:
disposing an inner molding (7) in the interior of an outer frame (6) while keeping a predetermined space (a) therebetween to be a peripheral wall (A) of the box;
disposing a given number of bell mouths according to one of claims 1 to 7, within said predetermined space (a) in such a manner that said bell mouths (B) lie horizontally with said trumpet-shaped openings (13) facing the side of said inner mold (7);
fixing said bell mouths (B) between said inner mold (7) and said outer frame (6);
placing a solidifyable material into said predetermined space (a);
solidifying said solidifyable material; and
removing said inner mold (7) and said outer frame (6) after solidification of said solidifyable material, thereby manufacturing said box with said given number of bell mouths (B) buried into the peripheral wall (A) of said box.

12. The method as set forth in claim 11, wherein said solidifyable material is concrete mortar.
